(19) United States
(12) Patent Application Publication
(10) Pub. No.: US 2007/0050697 A1
(43) Pub. Date: Mar. 1, 2007

(54) Integrated spreadsheet expanding table with collapsable columns

(75) Inventors: Alister Lewis-Bowen, Cambridge, MA (US); Louis M. Weitzman, Brookline, MA (US)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 11/209,229

(22) Filed: Aug. 23, 2005

(51) Int. Cl. G06F 17/00

(52) U.S. Cl. 715/503

(57) ABSTRACT

GUI selected rows of a displayed spreadsheet are collapsed based on column values such that all of the rows having the same value in the selected column are represented by a single collapsed row with an indicator indicating the row is collapsed. All column values of all the rows of the spreadsheet can be collapsed or individual column values can be collapsed. Collapsed rows are expanded for all rows or for a selected row. The expanded rows may be sorted, retain the original sequence but be grouped by column value or may be displayed in the original sequence with rows having different values.

### FIELD OF THE INVENTION

The present invention relates to the field of graphic user interfaces (GUIs) within computer systems. More specifically, the present invention relates managing presentations large spreadsheets or tables on a computer system.

### BACKGROUND OF THE INVENTION

Spreadsheet applications provide a matrix of cells. The matrix is made up of “rows”, a row having one or more horizontal cells and “columns”, a column having one or more vertical cells. Each cell of a row is positionally related, as is each cell of a column. Each cell can contain data or a formula for presenting data at the cell. The matrix of the spreadsheet can be sorted by column or row in order to rearrange the information in the matrix to make the presentation of the data more user friendly. A multi-column table is a simple form of a spreadsheet wherein data cell values are explicitly data rather than formulae. The terms “table” and “spreadsheet” will be used interchangeably within the present specification.

Data presented in a spreadsheet form is often difficult to work with when the number of rows or columns of the spreadsheet becomes large. For example, when a spreadsheet is sorted by column, the result might contain many rows of data for a single data attribute of the column. A spreadsheet having rows containing names, addresses and telephone numbers for New York City would result in a spreadsheet having millions of rows. Sorting for last names would organize the rows but there would still be thousands of rows of last names such as Jones or Smith for example. Spreadsheet technology permits “hiding” of columns or rows whereby the size of the viewable portion of the spreadsheet is reduced. This would not be of significant help in our example as there would still be millions of rows displayed even if some rows were hidden. A method is needed to improve the presentation of large spreadsheets.

Current user interface (UI) controls used to display lists of related information do not provide adequate methods for organizing and navigating very large amounts of information. In the past, spreadsheet applications have been used to display lists of related information.

U.S. Pat. No. 6,526,399 “Method and system for grouping and displaying a database” filed Jun. 15, 1999 incorporated herein by reference describes a database grouping and display system that groups a database by row and column in response to a user input. The database grouping and display system displays a raw, ungrouped database and allows a user to manipulate it as desired. The system displays the raw database and any manipulation results within a window of a web browser, thus allowing data analysis to be performed with the use of a common and inexpensive program. A user may group a database in order to group record entries within the database by common data entry. The user may group the record entries by row, by column, or by row and column. Each record entry grouping is referred to as a “metacell.” The database grouping and display system may further summarize the contents of each metacell and present a summary result along with the display of the metacell. This summary value is typically invoked for all metacells, but may alternately apply to a single row, column, or metacell, or for the entire document. The display state of the metacells may be toggled between a fully expanded and collapsed state. In the expanded state, all record entries within the metacell are visible, along with any summary values for the metacell. In a collapsed state, only summary values are shown in the metacell. This allows a user to see as much or as little detail for a metacell or range of metacells as desired. The method does not apply to spreadsheets having row/column matrix relationships.

U.S. Pat. No. 5,950,168 “Collapsible flowsheet for displaying patient information in an electronic medical record” filed Dec. 18, 1996 incorporated herein by reference describes in one embodiment, a user interface presents patient data on a computer display to a health care provider as a flowsheet including an array of category labels with indications of whether the category is in a collapsed state or an expanded state, the collapsed state being a state wherein data items in that category which are tagged as being hidden items are not displayed and the expanded state being a state wherein data items in that category which are tagged as being hidden items are displayed. Also included is a hierarchical structure of data items associated with at least some of the category labels, wherein parent data items are data items, which are above other data items in the hierarchical structure, and child data items are data items, which are below other data items in the hierarchical structure. For each parent data item, a zipper indicator is provided to indicate whether the parent data item is in a zipped state or an unzipped state, the zipped state being a state where child data items are not displayed below the parent data item and the unzipped state being a state where child data items are displayed below the parent data item. In addition, the columns corresponding to patient encounters can also be collapsed and expanded. The method does not apply to spreadsheets having row/column matrix relationships.

U.S. Pat. No. 6,205,453 “System and method for implementing selectively index enabled multi-column lists in a computer system” filed Mar. 13, 1998 incorporated herein by reference describes a system and method for implementing selectively index enabled multi-column lists in a graphical user interface for a computer system. The graphical user interface contains a table of entries organized by columns. The columns are displayed vertically adjacent to one another. A user selectable vertical line (the divider line) can be moved from an extreme left column position to a position between adjacent columns. When a column is between the divider line and the extreme left column position, the column becomes index enabled. A single column (e.g., the left most column) or multiple columns can be index enabled simultaneously. A column can be positioned between the divider line and the extreme left column position by column reordering, e.g., leaving the divider line in a fixed position and dragging and dropping the column from a position right of the divider line. By making a column index enabled, an index of the items of the column is made and when indexed, every unique column item is represented only once in the column by an index item. A user selectable two-position representation (e.g., a triangle, arrow, etc.) can be used to open (expand) or close the index item. When closed, all information contained within the index item is collapsed in the user interface. When expanded, this information can be displayed in the user interface. The present invention advantageously provides advantages of tree-views (e.g., the ease of searching through data in a hierarchical format) while also offering advantages of multi-column list displays (e.g., volume of information presentation).

Many spreadsheet columns do not have any hierarchical relationship. Even where one exists, moving rows to the left of a vertical bar in order to provide the hierarchical format disturbs the familiar relationship perception of the user.

An improved spreadsheet presentation method is needed to facilitate the use of large spreadsheets.

### SUMMARY OF THE INVENTION

In an aspect of the invention a spreadsheet (Table) is an N by M matrix of cells arranged by a user to provide information in a useful relationship between cells. Individual cells can be edited, copied, pasted etc. In typical applications, rows of the matrix can be arranged by sorting the rows based on values of cells in a selected column. The present invention provides a facility for a user controlled collapsing of rows to facilitate manipulation of large spreadsheets. Thus, rows having cell values that are common in a given row can be collapsed to a single row represented by the cell value and preferably a highlight indicator indicating the row is a collapsed representation of multiple rows. This facility greatly reduces the number of rows that are presented at a time. A collapsed row can be expanded, restoring the values of the original rows.

It is therefore an object of the present invention to provide a spreadsheet wherein the spreadsheet comprises a single N by M matrix of contiguous data cells, the matrix of data cells forming a plurality of N rows and a plurality of M columns wherein a first column of the matrix is collapsed by a user action, the first column comprising first data cells having corresponding first data cell values.

It is another object of the invention to determine a plurality of first rows of the plurality of N rows having duplicate first data cell values and then collapsing the plurality of determined first rows of the plurality of N rows to display a single collapsed row representing the plurality of first rows, thereby hiding the plurality of first rows.

It is another object of the invention to display a highlight at the first data cell of the collapsed first row to indicate the row is collapsed.

Preferably the plurality of M columns comprises the first column of the matrix having one or more second columns to the left of the first column in the matrix.

It is yet another object of the invention, to leave the second columns un-collapsed.

It is another object of the invention to provide a collapsed first row comprising the first data cell and one or more second data cells wherein optionally, the values of cells other than the first data cell value of the collapsed row are hidden.

It is another object of the invention to provide a collapsed first row comprising the first data cell and one or more second data cells wherein optionally, the values of cells other than the first data cell value of the collapsed row are display.

It is another object of the invention to provide a collapsed first row comprising the first data cell and one or more second data cells wherein optionally, one of the first rows is selected to be the collapsed first row.

It is another object of the invention to provide a collapsed first row comprising the first data cell and one or more second data cells wherein optionally, a pre-collapse row order of the first rows is saved, then the collapsed first rows are expanded to the pre-collapse row saved order.

It is another object of the invention to provide a collapsed first row comprising the first data cell and one or more second data cells wherein optionally, the collapsed first rows are expanded in a predetermined sorted first cell order.

It is yet another object of the invention to display an expand highlight at a first data cell of a row of the plurality of rows having duplicate first data cell values indicating the rows are expanded.

It is a further object of the invention to perform the collapsing as part of a column sort operation.

It is another object of the invention to select a portion of a cell as the first data value.

It is another object of the invention to provide a collapse/expand highlight consisting of any one of a shape, a color, a text character, shading or a modified cell value.

It is another object of the invention to provide a spreadsheet that is a selected portion of a larger spreadsheet.

It is another object of the invention to provide a collapsed row that is any one of expanded to its original sequence in contiguous rows or expanded to its original sequence in non-contiguous rows.

It is yet another object of the invention to collapse rows of the spreadsheet according to a Boolean criteria.

It is another object of the invention to provide a Boolean collapsed row that is highlighted by a special indicator wherein preferably the special indicator is a widget indicating Boolean collapsing criteria.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting components of a computer system;

FIG. 2 is a diagram depicting a network of computer systems;

FIGS. 3-12 depicts views of an example spreadsheet according to the invention;

FIG. 13 depicts an example manipulation process of the present invention;

FIG. 14 is a flow depicting an example manipulation process of the invention;

FIG. 15 is a flow depicting an example row display process of the invention;

FIG. 16 is a flow depicting an example element collapsing process of the invention;

FIG. 17 is a flow depicting an example collapsing and sorting according to the invention;

FIG. 18 is a flow depicting an example collapsing process of the invention;

FIG. 19 is a flow depicting row hiding according to the present invention;

FIG. 20 is a flow depicting collapsing rows to empty sets; and

FIG. 21 is a flow depicting collapsing and expanding of rows.

The detailed description explains the preferred embodiments of the invention, together with advantages and features, by way of example with reference to the drawings.

### DESCRIPTION OF THE PREFERRED EMBODIMENTS

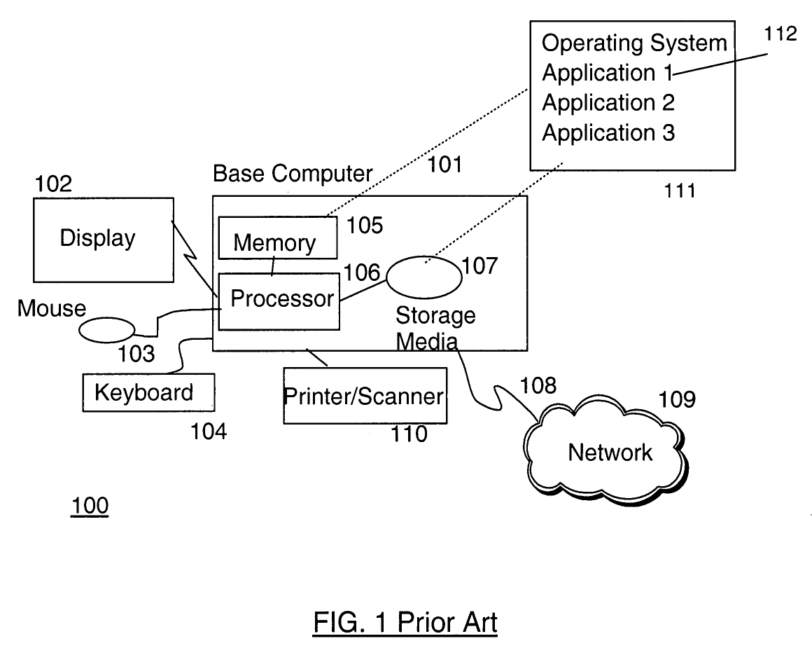

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

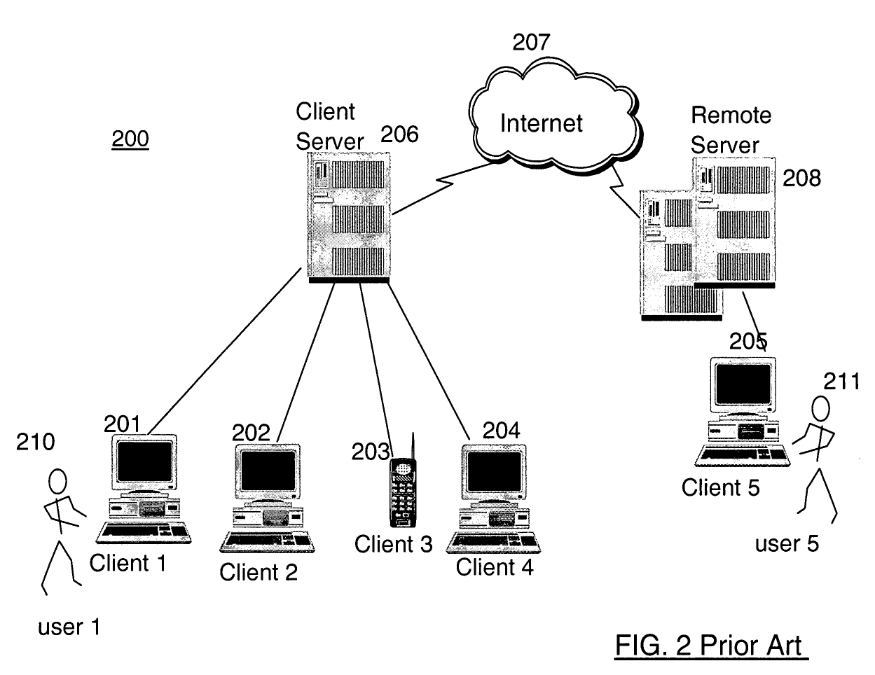

FIG. 2 illustrates a data processing network 200 in which the present invention may be practiced. The data processing network 200 may include a plurality of individual networks, such as a wireless network and a wired network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zSeries® 900 Server available from IBM Corp.

Software programming code, which embodies the present invention, is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system, which controls the function and interaction of the various computer components and one or more application programs. Program code is normally paged from dense storage media 107 to high-speed memory 105 where it is available for processing by the processor 106. The techniques and methods for embodying software programming code in memory, on physical media, and/or distributing software code via networks are well known and will not be further discussed herein.

In the following detailed description of the system and method for implementing selectively collapsible multi-column lists (or spreadsheets) in a graphical user interface, of the present invention, numerous specific details are set forth in order to provide a thorough understanding of the present invention. However, it will be obvious to one skilled in the art that the present invention may be practiced without these specific details. In other instances well known methods, procedures, components, and circuits have not been described in detail as not to unnecessarily obscure aspects of the present invention.

Some portions of the detailed descriptions, which follow, are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, step, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention provides a graphic user interface (GUI) for displaying information to a user of a computer system. The present invention provides selectively collapsible multi-column lists (SCMCLs). The SCMCL enables individual columns to be made collapsible at the option of the user. If no column is so enabled, then the present invention, in this mode of operation, resembles a standard multi-column list. The typical mode of operation for the present invention is to have some columns of the list collapsible and some not.

Preferably, when a column is made collapsible, it is initially collapsed by default in one embodiment of the present invention. When a column is collapsed in accordance with the present invention, every item is represented only once in the column. The user can expand a collapsed item (when there is more than one instance of the item) to see all the instances of rows having the item. For instance, assume a spreadsheet in accordance with the present invention contains 500 rows comprising instances of 40 unique author names and the author column is collapsible. In this case, the spreadsheet displayed would contain only 40 rows wherein the author column would contain only the 40 unique author names (e.g., collapsible items) instead of 500 names. Each unique author name would then be accompanied by an expansion button (a graphical item displayed on the screen). When the expansion button of an author is selected, the spreadsheet of the present invention reveals (e.g., expands to display) all the rows of that author.

In accordance with the present invention, any column of the spreadsheet can be made collapsible. In one embodiment, rows of a spreadsheet are collapsed when a sort operation on a collapsible column is performed.

In another embodiment, columns are expanded to the original row sequence.

In another embodiment, a selected collapsed group of rows is expanded to original sequence.

In another embodiment, a selected collapsed group of rows is expanded to a sorted sequence.

In another embodiment, a selected collapsed group of rows is expanded to the original relative position in the total matrix, thus the expanded group rows would in some cases have interlaced rows of non-group members.

The variations of collapsing and expanding rows by column group or by full column in one embodiment are controlled by a GUI drop-down window that displays the options in response to a user selecting a column widget or a row widget.

The SCMCL of the present invention preferably supports ordered sorting. For instance, if the user sorts a column that is collapsible, e.g. “name,” and then sorts a column on the right, e.g., “date,” the rows in the result would be sorted by name and wherever there is a name that appears more than once, it would be sorted by date. This embodiment can be extended to all columns that are collapsible.

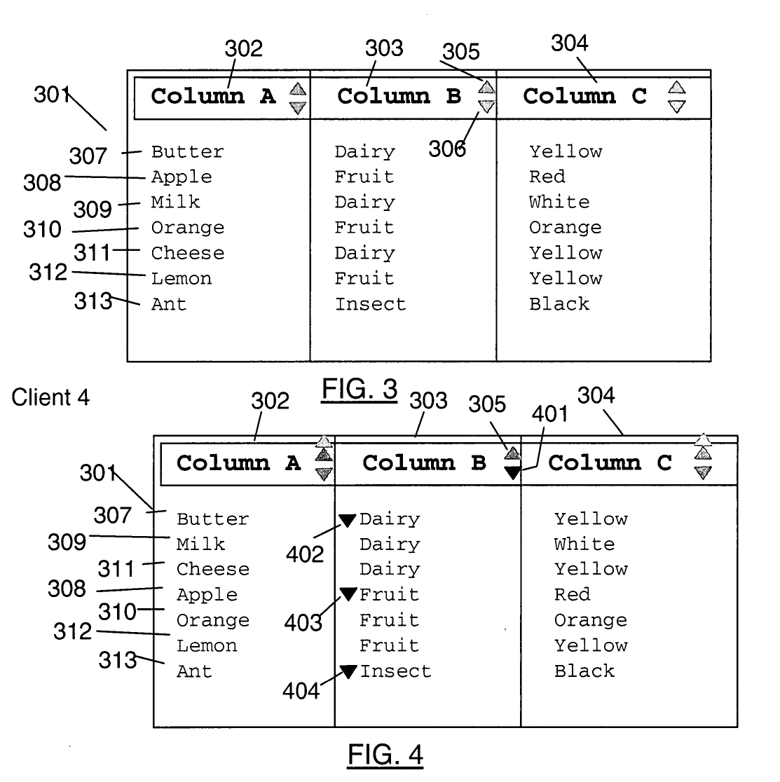

By way of example, with reference e to FIG. 3 representing a spreadsheet 301 as displayed at a computer screen 102. The spreadsheet 301 is comprised of 3 columns 302 303 304. The columns “Column A” 302, “Column B” 303 and “Column C” 304 comprise “Expandable” widgets 306 and “collapsible” widgets 305. A first row 307 is comprised of cells, one cell for each row. The value of the cells of the first row 307 is “Butter” in the first column 302, “Dairy” in the second column 303 and “Yellow in the third column 304. Seven rows are depicted 307 308 309 310 311 312 313.

In the example referring now to FIG. 4, it is desirable to collapse column 2 303. The expand widget 401 is selected in column 2 303 which causes the rows of the spreadsheet to be sorted according to the value of the cells of the second column. Thus all the rows having Dairy are contiguous; all the rows having Fruit are contiguous. Preferably, an indicator or highlight widget 402 403 404 is applied to the spreadsheet to show the beginning of the list of duplicated cell values. The highlight widget 402 403 404 can be selected by a user to cause the associated rows having the same column 2 401 values to collapse.

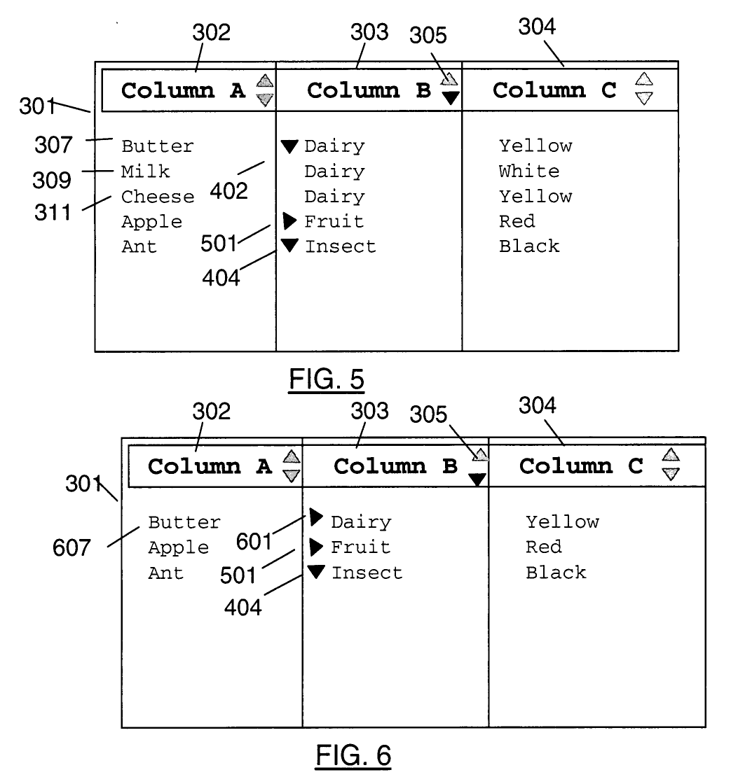

FIG. 5 shows our example spreadsheet 301 as a result of a user selecting the Fruit highlight 403 resulting in the collapse of the FRUIT rows 310 311 into a single row. The Fruit highlight is modified to provide a visual indication 501 that the Fruit row is collapsed. The Dairy rows 307 308 309 and the Insect row 313 are not collapsed.

FIG. 6 shows the spreadsheet 301 of FIG. 5 except that the user has further collapsed the rows associated with Dairy 307, 309, 311 into a single row and the highlight associated with Dairy 402 is modified 601 to show the Rows have been collapsed.

In the embodiment, the value of the cells of the row 607 resulting from the collapsed rows 307, 309, 311 contain the value of the cells of one of the rows collapsed (preferably the value of the first row 307).

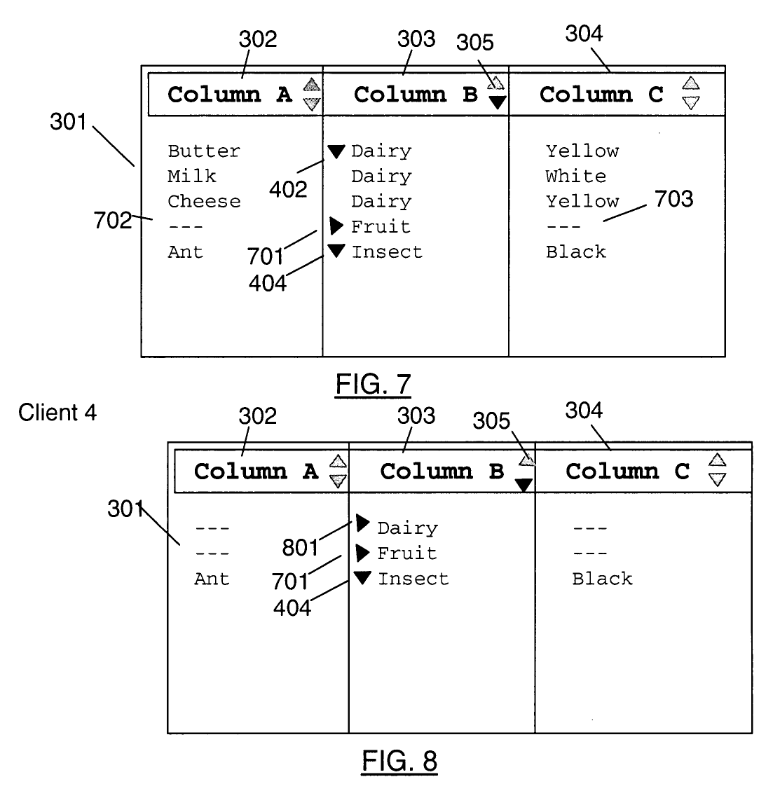

In another embodiment FIG. 7 shows that the collapsed Fruit row 701 hides the values of the other cells 702 703 of the collapsed rows.

Then when the Dairy rows are collapsed 801 in FIG. 8, the values of the other cells of the row are hidden as well.

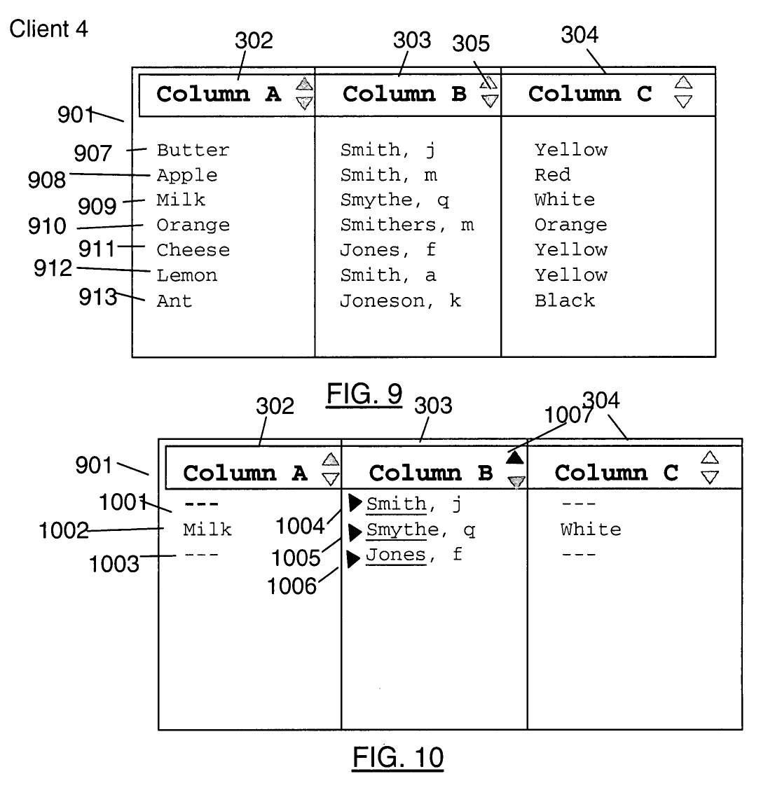

In another embodiment, only a portion of the value of the collapsible cell is analyzed in order to select rows to collapse. In FIG. 9, a similar spreadsheet 901 contains names in the second column 303. In this embodiment, the user is prompted for cell value portions to use in determining duplicate rows. This would be useful, for example, when a column contained dates comprising Month, Day and Year. The user could then collapse the spreadsheet to show only unique years by selecting the cell data position containing the year values. In our example, referring now to FIG. 10, the user selects the first 5 characters of the last name as the value on which to base collapsing. When the user collapses the rows of the selected column (by selecting the collapse widget 1007, only rows having last names with unique first 5 characters 1004 1005 1006 are shown in the spreadsheet 901. In a preferable embodiment, the portion of the cell value used to collapse is highlighted, for instance using underlining, as in FIG. 10. Note, in the example, Smithers row 910 is collapsed with Smith rows 907 908 912 as they both have “Smith” in the first 5 characters.

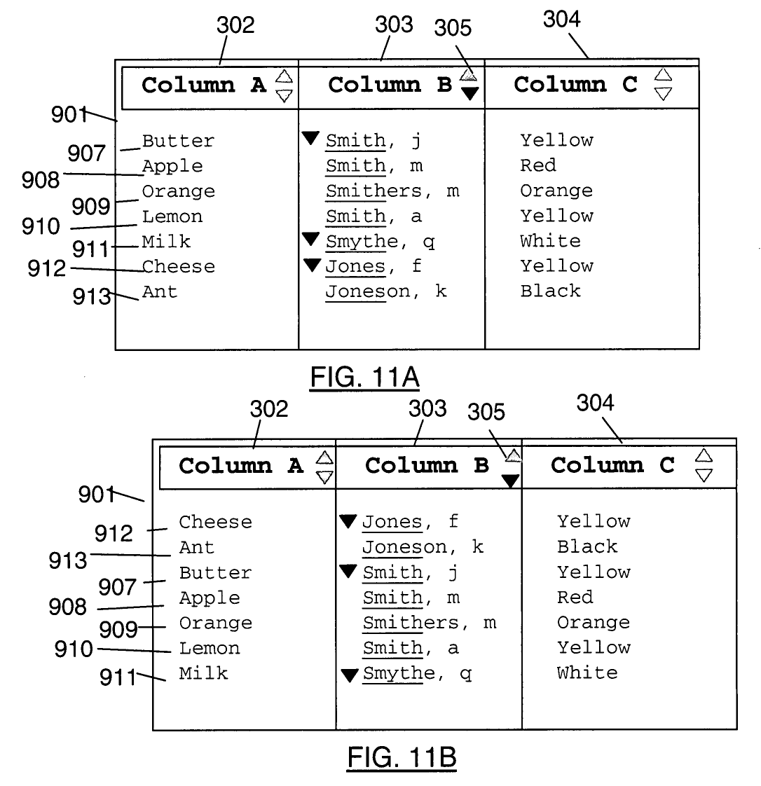

It should be noted, that while a preferred mode sorts the rows by the cell contents of the selected column 303 as part of the collapsing mechanism (as shown in FIG. 11), another mode would merely collapse rows according to the sequence new cell content values are encountered as shown in FIG. 10.

FIG. 11A depicts the collapsed rows of FIG. 10 having been expanded in an embodiment that retains the order of the collapsed rows of rows in FIG. 10 and the relative order of the rows having the same value in the second column 303.

FIG. 11B depicts the collapsed rows of FIG. 10 having been expanded in an embodiment that sort the rows according to values of the second column 303.

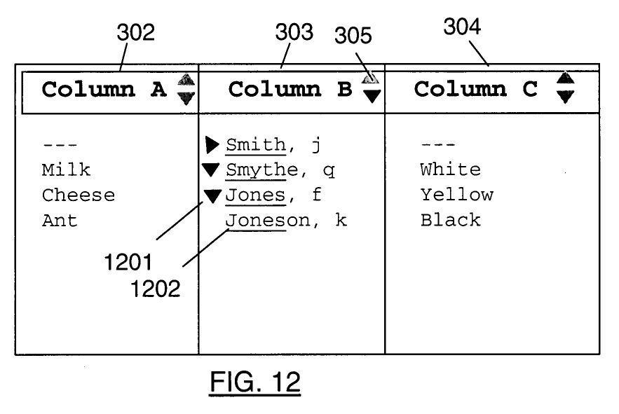

In a preferred embodiment, the highlight widget for collapsing a column once selected continues to display the selected mode to further indicate the selected column 303. The column collapse highlight widgets 305 306 operate on all rows while the cell highlight widgets 1004 1005 1006 operate on the duplicated rows only as shown in FIG. 12 where the collapsed row having Jones 1006 as a value is expanded to show Jones 1201 and then Joneson 1202.

In an embodiment, each group of rows that share a duplicate cell value of a selected column, are highlighted by providing alternating shading, text color, background color or horizontal line.

In an embodiment, the triangle icons of the previous embodiments could be other icon forms including +/−etc. as are well known in the art.

A user may choose to collapse multiple columns sequentially. In one embodiment, the second column collapsed retains the collapsed form of the previous column collapsed. It should be understood that there is no proximity requirement for a column to be collapsed. Any column of the spreadsheet can be selected to collapse without requiring rearranging the columns. In fact, non-adjacent columns may be chosen for multiple column collapsing. Furthermore, a portion of the spreadsheet might be collapsed/expanded by painting the area of the spreadsheet to be operated on and then performing the collapse/expand function.

In an embodiment, collapsing is performed by a Boolean operator. Thus, a user provides a Boolean input to the collapsing mechanism and the spreadsheet is collapsed accordingly. In our example, all rows having “dairy” in column B and “yellow” in column C could be collapsed based on the Boolean input of B=“Dairy”<and> C=“yellow”. As a further example, the Boolean function could be a range, thus B=“Dairy”<and> C>“y”<and> C<“z” would result in all rows having Dairy in column B and anything starting with “y” in column C being collapsed together in a single row. In one embodiment, the collapsed row would have a special highlight for the Boolean function that would aid the user in knowing the content. For example, the highlight might be a “**” that is a widget that expands to show the Boolean equation.

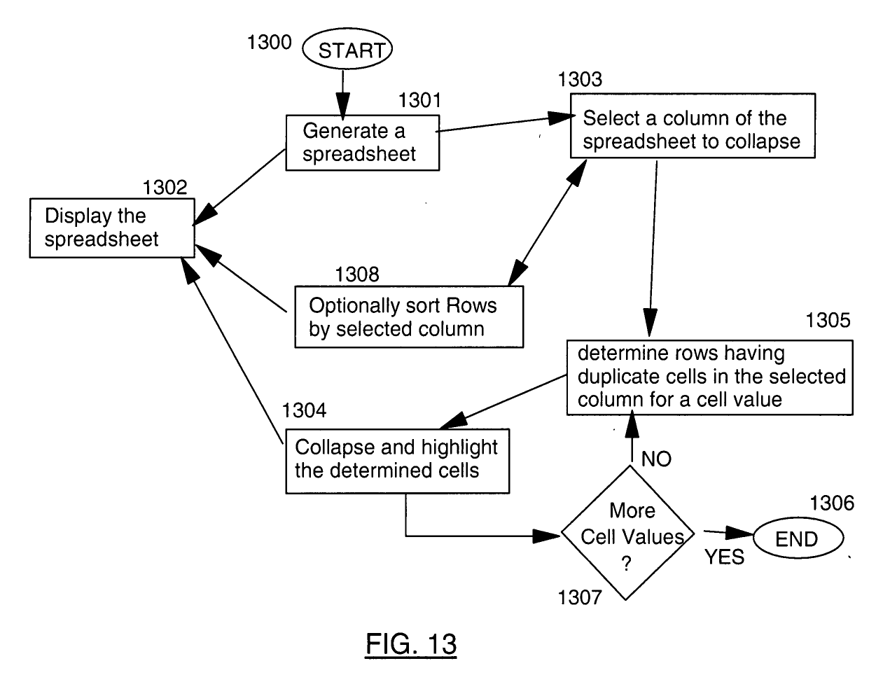

Referring to FIG. 13, a user begins 1300 by generating a spreadsheet 1301 by employing a method according to the prior art. The generated spreadsheet is displayed 1302 at the users computer system as it is being manipulated by the user. The user determines that the very large spreadsheet is difficult to deal with even after sorting various columns and hiding columns according to methods of the prior art. The user elects to select 1303 a column of the spreadsheet to collapse employing the present invention. The user may elect to optionally 1308 sort rows of the selected column being collapsed. and display the sort results 1302. The application program employing the present invention determines 1305 rows having duplicate cells in the selected column for a cell value and collapses 1304 any determined rows found having that value. The application program determines 1307 if there are any other un-collapsed cell values in the column and, if any exist proceeds to determine rows 1305 having duplicate cells to that new value. When the application program determines 1307 that there are no more cell values to collapse in the column, the application displays 1302 the resulting spreadsheet with collapsed rows and returns control to the user 1306. Preferably collapsed rows 1304 are highlighted with a widget to indicate that the row can be expanded (by selecting the widget).

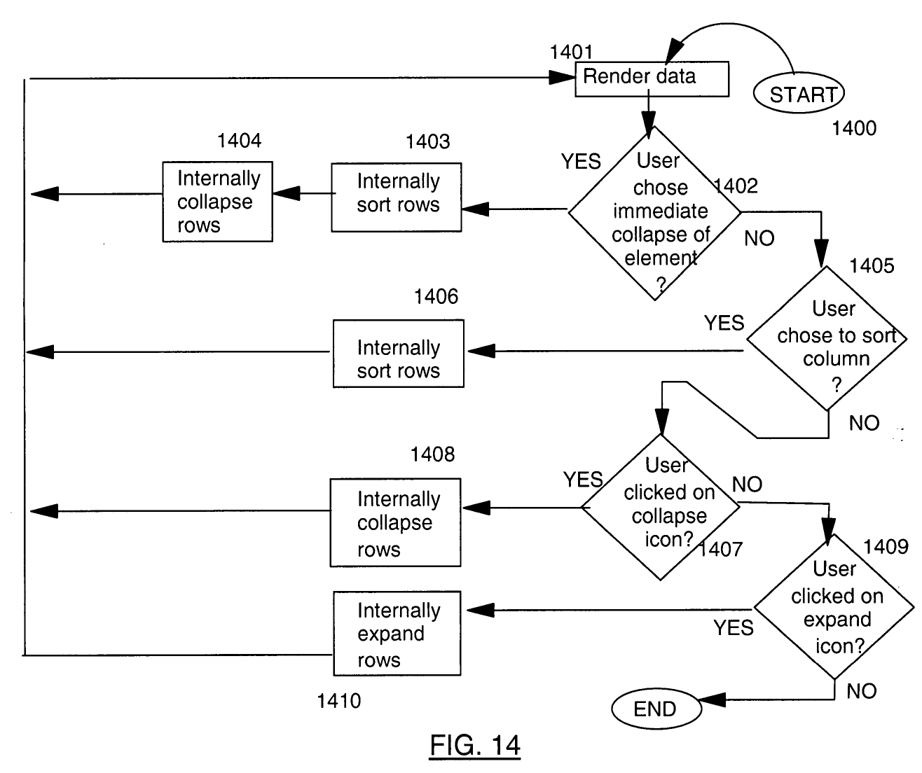

FIG. 14 depicts a flow of an example embodiment. The system first renders 1401 the display of the tabular data (spreadsheet). The user can then sort, collapse or expand depending on the state of the various rows of the data.

In this embodiment, each element (or cell) of the table (spreadsheet) maintains a list of collapsed rows that it potentially managers. When a row is collapsed, it is removed from a list of visible rows and put on the element's internal list of collapsed rows. When an element is expanded, its internal list is cleared and the collapsed rows are put back on the list of visible rows. The main interactions for the user are to select a column and sort (or sort and collapse) it, select an element and sort (or sort and collapse) it, or select the icons that control the collapsing and expanding of adjacent similar rows. Only if there is something to collapse or expand will those icons be present and the decision points in the algorithm be possible.

In the example, the user displays the spreadsheet 1401, preferably in response to a GUI prompt, the user chooses 1402 to collapse an element of the spreadsheet for a selected column. An application program, in response sorts the rows 1403 according to the cells of the selected column and then collapses 1404 rows having the same values in the cells of the column selected and displays 1401 the resulting collapsed spreadsheet.

The user may instead choose 1405 to sort a column. The application sorts 1406 the rows based on the cells of the selected column and displays 1401 the resulting sorted spreadsheet.

The user may instead choose 1407 to collapse an element marked with an icon. The application will collapse 1408 the rows associated with the icon.

The user may instead choose to expand 1409 a collapsed row by selecting an expand icon. The application will expand 1410 the rows associated with the icon.

Preferably, the order of the collapsing operations is maintained. This is used to reverse the order of the collapse operations when expanding them. A variable maintains the identity of the currently sorted column.

Variables used in an example algorithm:

currentRow: the current row being rendered during display element.

collapsedRows: each element maintains a list of potentially collapsed rows

visibleRows: the list of currently visible rows in the table

sortedColumn: currently sorted column

Render display;

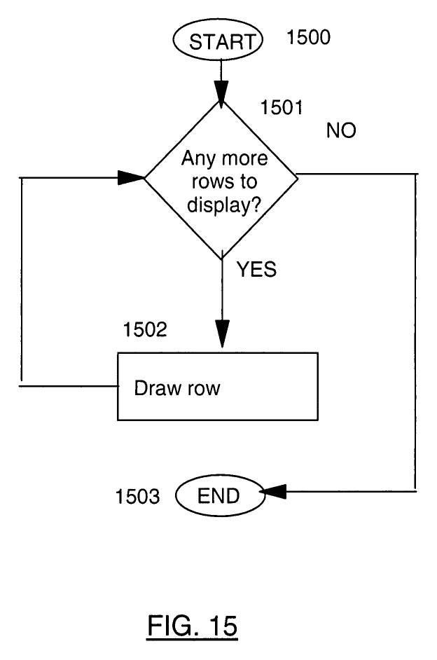

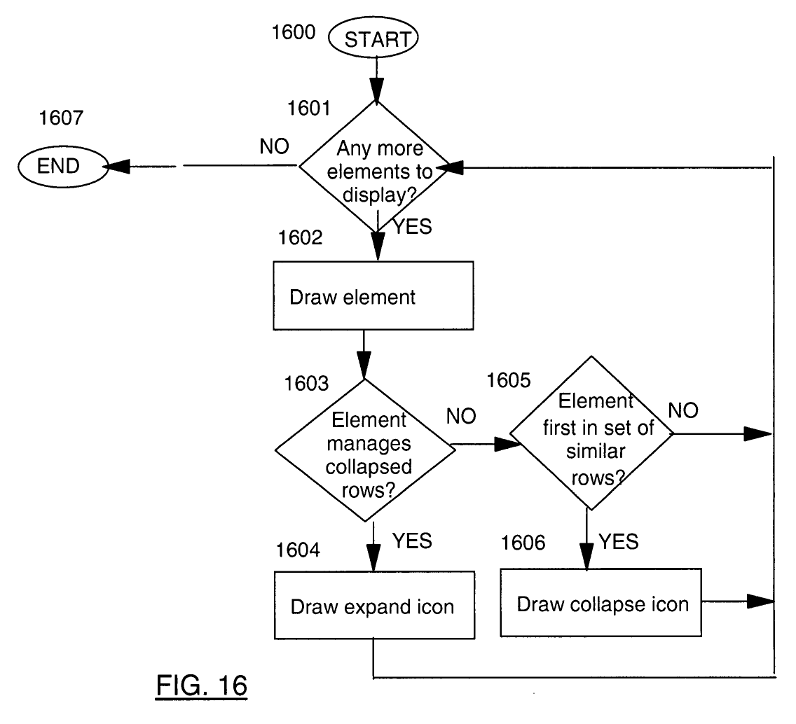

Referring now to FIG. 15 and FIG. 16, initially 1500, the system renders the table (or spreadsheet) data. The rendering proceeds looping 1501 over the list of visibleRows setting the currentRow to the next row in the loop. It renders 1502 that row drawing 1602 each element in the row in its appropriate column. If 1603 a particular element in the row has a set of collapsedRows it is maintaining, an icon is placed 1604 next to that element to indicate that it can be expanded in a subsequent step of the algorithm. If 1603 that element does not have a list of collapsedRows it is maintaining and there are similar rows 1605 (based on the sortedColumn's value), a mark is placed next to that element to indicate that the element (and the similar ones below it) can be collapsed in a subsequent step of the algorithm 1606. The processing continues over all the visible rows.

Sort:

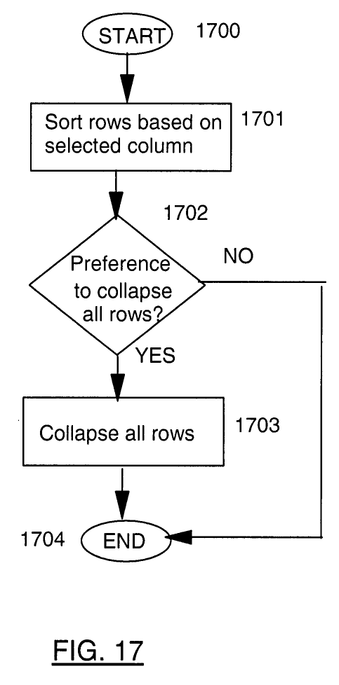

Referring to FIG. 17, to initiate 1700 a sort 1701, the user in an embodiment, prefers 1702 to collapse all the rows 1703 of the column and therefore selects the heading of a row. The user can also prefer 1702 select an element and use a context menu (right-click menu) to sort the rows. The sortedColumn is set to the column selected. The system then sorts all rows based on the value in the sortedColumn column. This is standard in the industry for widgets containing tabular data. According to a user preference, the system may also automatically collapse all rows 1703 with similar values in the sortedColumn.

Collapse:

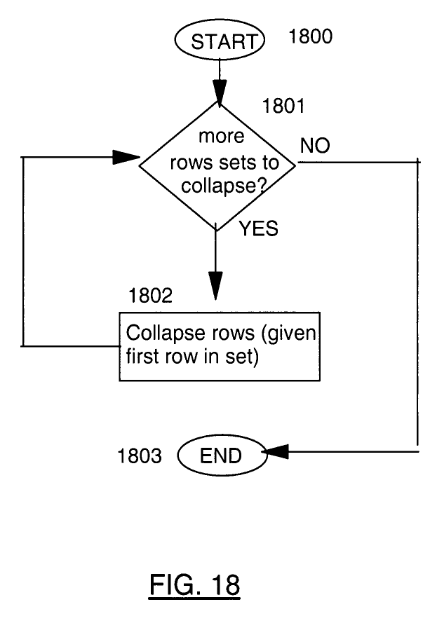

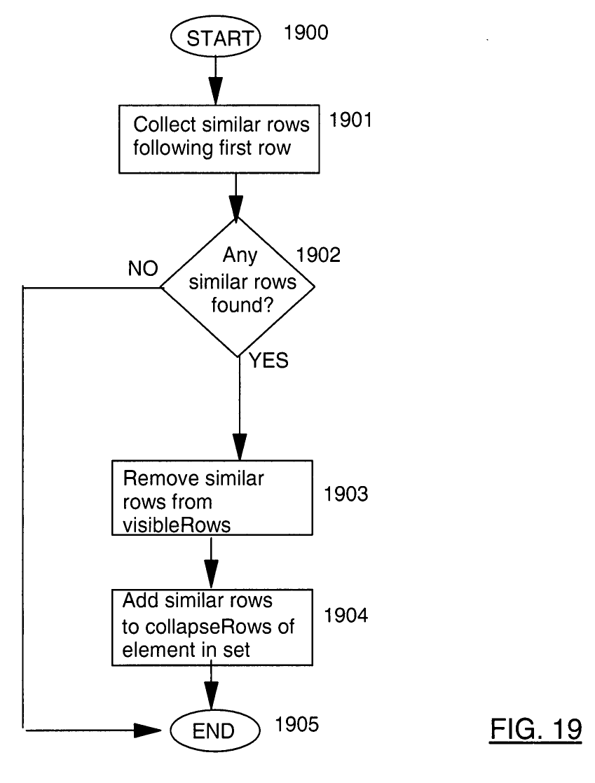

Referring to FIG. 18 and FIG. 19, the user initiates 1800 the collapse step of the algorithm by clicking on a mark to collapse a continuous set of rows. Alternatively, the user could have selected a context menu to collapse 1802 a particular element in the data. The application program would continue 1801 collapsing the rows until no more rows were found 1801. The application would preferably collect similar rows following the first row 1901 and 1902 remove similar rows from visibleRows 1903 and add similar rows to collapseRows of an element set 1904 until there were no more similar rows found 1902. This would sort the data by the column of the element chosen and automatically collapse rows with similar values.

Expand:

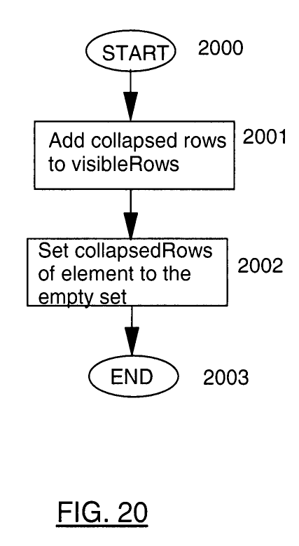

Referring to FIG. 20, the user initiates 2000 the expand step of the algorithm by clicking on the icon to expand a previously collapsed set of rows. The collapsed rows are added back into the set of visibleRows 2001. The data is re-rendered changing the icon to an expand icon. The collapsedRows element is set to the empty set 2002.

This process can continue by sorting and collapsing additional columns. When additional columns are sorted and collapsed, the expansion occurs in the reverse order, reversing the sequence of collapse operations.

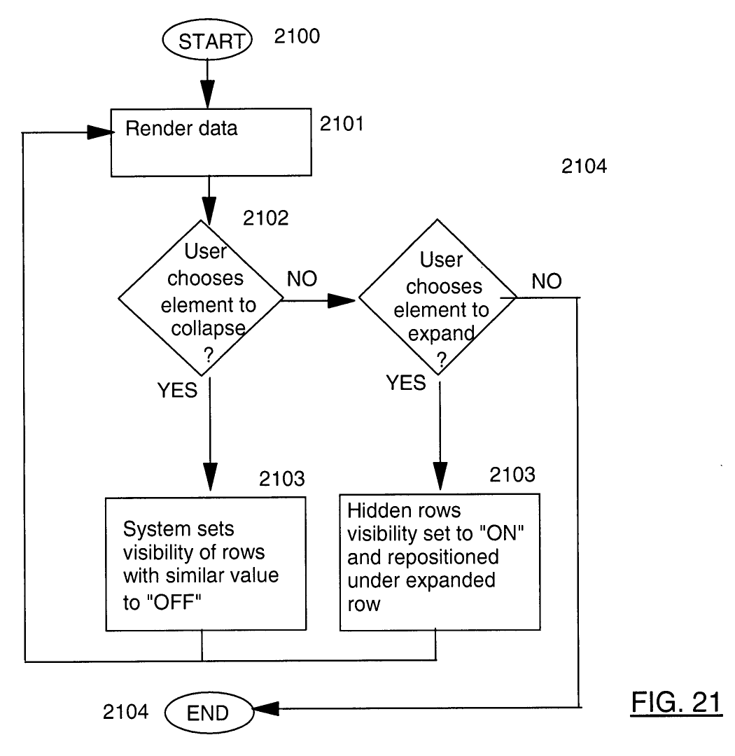

Referring to FIG. 21, the user can select an element to collapse or expand. The data is displayed 2101 and preferably a GUI interface provides a mechanism of a user to select an element to collapse 2102. The application program hides rows having values of the selected element cell are hidden 2103 and the spreadsheet without the hidden rows is rendered 2101 on the display. The application marks the corresponding rows in an internal file with an “off” indicator, which the application uses to remember whether to display the row or not. Preferably, the application inserts a widget at the cell selected, indicating the row is a collapsed row. On the other hand, the user may choose to expand 2104 collapsed rows. The user selects 2104 a widget of the collapsed row in (the widget associated with the cell of the collapsed row that the row was collapsed around). The application permits 2103 the hidden cells to be visible by marking an internal file with an “on” indicator, which the application uses to remember whether to display the row or not and the spreadsheet with the previously hidden cells are rendered 2101.

In an embodiment, any element can be the “representative” for the collapsed item (i.e., the user can choose any row and it can become the top of the collapsed set).

In an embodiment, the system could automatically hide all non-unique rows for a given column. The order of the unique rows is maintained from the original. As the user expands the sets, they appear below the representative row.

In another embodiment, the process begins with the user selecting (right-click on a row element) a collapse command from the menu. This would automatically sort and collapse all rows with similar data with one user action.

In another embodiment, it would be possible to reverse rows and columns and produce a similar collapse/expand effect in the horizontal instead of vertical dimension.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment of the invention has been illustrated and described herein, it is to be understood that the invention is not limited to the precise construction herein disclosed, and the right is “reserved” to all changes and modifications coming within the scope of the invention as defined in the appended claims.

What is claimed is:

1. A computer implemented method for presenting a spreadsheet, the method comprising the steps of:
a) generating and displaying the spreadsheet, the spreadsheet comprising a single N by M matrix of contiguous data cells, the matrix of data cells forming a plurality of N rows and a plurality of M columns;
b) selecting a first column of the matrix to collapse, the first column comprising first data cells having corresponding first data cell values;
c) determining a plurality of first rows of the plurality of N rows having duplicate first data cell values;
d) collapsing the plurality of determined first rows of the plurality of N rows to display a single collapsed row representing the plurality of first rows, thereby hiding the plurality of first rows;
e) displaying a highlight at the first data cell of the collapsed first row to indicate the row is collapsed; and
f) repeating steps c) through e) for each first data cell value of the first column.

2. The method according to claim 1 wherein the plurality of M columns comprises the first column of the matrix having one or more second columns to the left of the first column in the matrix.

3. The method according to claim 2 wherein the second columns are not collapsed.

4. The method according to claim 1 wherein the collapsed first row comprises the first data cell and one or more second data cells comprising further steps consisting of any one of:
hiding the values of cells other than the first data cell value of the collapsed row;
displaying the values of cells other than the first data cell value of the collapsed row;
selecting one of the first rows to be the collapsed first row;
saving a pre-collapse row order of the first rows, then expanding the collapsed first rows to the pre-collapse row order; or
expanding the collapsed first rows in a predetermined sorted first cell order.

5. The method according to claim 1 comprising the further steps of:
displaying an expand highlight at a first data cell of a row of the plurality of rows having duplicate first data cell values indicating the rows are expanded.

6. The method according to claim 1 wherein the collapsing is performed as part of a column sort operation.

7. The method according to claim 1 comprising the further step of selecting a portion of a cell as the first data value.

8. The method according to claim 1 wherein the highlight consists of any one of a shape, a color, a text character, a shading or a modified cell value.

9. The method according to claim 1 wherein the spreadsheet is a selected portion of a larger spreadsheet.

10. The method according to claim 1 wherein a collapsed row is any one of expanded to its original sequence in contiguous rows or expanded to its original sequence in non-contiguous rows.

11. The method according to claim 1 wherein rows of the spreadsheet are collapsed according to a Boolean criteria.

12. The method according to claim 11 wherein a Boolean collapsed row is highlighted by a special indicator.

13. The method according to claim 12 wherein the special indicator is a widget indicating Boolean collapsing criteria.

14. A computer program product for presenting a spreadsheet, the computer program product comprising:
a storage medium readable by a processing circuit and storing instructions for execution by a processing circuit for performing a method comprising:
A computer implemented method for presenting a spreadsheet, the method comprising the steps of:
a) generating and displaying the spreadsheet, the spreadsheet comprising a single N by M matrix of contiguous data cells, the matrix of data cells forming a plurality of N rows and a plurality of M columns;
b) selecting a first column of the matrix to collapse, the first column comprising first data cells having corresponding first data cell values;
c) determining a plurality of first rows of the plurality of N rows having duplicate first data cell values;
d) collapsing the plurality of determined first rows of the plurality of N rows to display a single collapsed row representing the plurality of first rows, thereby hiding the plurality of first rows;
e) displaying a highlight at the first data cell of the collapsed first row to indicate the row is collapsed; and
f) repeating steps c) through e) for each first data cell value of the first column.

15. The computer program product according to claim 14 wherein the plurality of M columns comprises the first column of the matrix having one or more second columns to the left of the first column in the matrix wherein the second columns are not collapsed.

16. The computer program product according to claim 14 wherein the collapsed first row comprises the first data cell and one or more second data cells comprising further steps consisting of any one of:
hiding the values of cells other than the first data cell value of the collapsed row;
displaying the values of cells other than the first data cell value of the collapsed row;
selecting one of the first rows to be the collapsed first row;
saving a pre-collapse row order of the first rows, then expanding the collapsed first rows to the pre-collapse row order; or
expanding the collapsed first rows in a predetermined sorted first cell order.

17. The computer program product according to claim 14 comprising the further steps of:
displaying an expand highlight at a first data cell of a row of the plurality of rows having duplicate first data cell values indicating the rows are expanded.

18. A system presenting a spreadsheet, the system comprising:
a network;
a first computer system in communication with the network wherein the computer system includes instructions to execute a method comprising the steps of:
a) generating and displaying the spreadsheet, the spreadsheet comprising a single N by M matrix of contiguous data cells, the matrix of data cells forming a plurality of N rows and a plurality of M columns;
b) selecting a first column of the matrix to collapse, the first column comprising first data cells having corresponding first data cell values;
c) determining a plurality of first rows of the plurality of N rows having duplicate first data cell values;
d) collapsing the plurality of determined first rows of the plurality of N rows to display a single collapsed row representing the plurality of first rows, thereby hiding the plurality of first rows;
e) displaying a highlight at the first data cell of the collapsed first row to indicate the row is collapsed; and
f) repeating steps c) through e) for each first data cell value of the first column.

19. The system according to claim 18 wherein the plurality of M columns comprises the first column of the matrix having one or more second columns to the left of the first column in the matrix, wherein the second columns are not collapsed.

20. The system according to claim 18 wherein the collapsed first row comprises the first data cell and one or more second data cells comprising further steps consisting of any one of:
hiding the values of cells other than the first data cell value of the collapsed row;
displaying the values of cells other than the first data cell value of the collapsed row;
selecting one of the first rows to be the collapsed first row;
saving a pre-collapse row order of the first rows, then expanding the collapsed first rows to the pre-collapse row order; or
expanding the collapsed first rows in a predetermined sorted first cell order.
